(19) United States
(12) Patent Application Publication
(10) Pub. No.: US 2012/0279691 A1
(43) Pub. Date: Nov. 8, 2012

(54) HEAT EXCHANGER FOR A MOTOR VEHICLE AIR CONDITIONING SYSTEM

(75) Inventors: Lothar SEYBOLD, Nauheim (DE); Artem SERYI, Wiesbaden (DE)

(73) Assignee: GM GLOBAL TECHNOLOGY OPERATIONS LLC, Detroit, MI (US)

(21) Appl. No.: 13/463,937

(22) Filed: May 4, 2012

(30) Foreign Application Priority Data
May 6, 2011 (DE) 10 2011 100 683.8

(51) Int. Cl. F28D 7/10; B23P 15/26

(52) U.S. Cl. 165/154; 29/890.036

(57) ABSTRACT

A heat exchanger for a motor vehicle air conditioning system is provided. The heat exchanger includes an inner tube configured to carry a heat exchanger medium and an outer tube that at least regionally envelops the inner tube with an intermediate space between the inner tube and the outer tube. A separating web extends between the inner tube and the outer tube and is configured to divide the intermediate space into at least two flow channels. In an axial section of the inner tube and the outer tube, the separating web fluidically couples the flow channels with each other as viewed in a circumferential direction of the inner tube.

### CROSS-REFERENCE TO RELATED APPLICATION

This application claims priority to German Patent Application No. 10 2011 100 683.8 filed May 6, 2011, which is incorporated herein by reference in its entirety.

### TECHNICAL FIELD

The technical field generally relates to a heat exchanger or heat transferring device for a motor vehicle air conditioning system, which is configured in particular to exchange thermal energy inside a refrigerant circuit.

### BACKGROUND

Known in the art for increasing the performance and efficiency of motor vehicle air conditioning systems are air conditioner-internal heat exchangers, so-called internal heat exchangers (IHX), which thermally couple a section of the refrigerant circuit running between the evaporator and compressor with a section of the refrigerant circuit running between the capacitor and expansion valve. In this way, the relatively cold refrigerant flowing from the evaporator to the compressor can be used to (pre)cool or supercool the comparatively warm refrigerant supplied to the expansion device on the high-pressure side of the refrigerant circuit.

For example, DE 10 2005 052 972 A1 describes a two-walled heat exchanger tube with an outer tube and inner tube, which define a channel between them. The high-pressure refrigerant here flows through the channel, and the low-pressure refrigerant flows through the inner tube.

The geometric dimensions and shapes of the tubes are of importance for optimizing the function of such heat exchangers in the refrigerant circuit. In an existing vehicle package, which offers no space for individually adapting or changing the outer contour or outer geometry of the heat exchanger, it is comparatively difficult to individually adjust such heat exchangers to prescribed requirements in terms of their heat exchanger capacity, for example, specific to the vehicle type.

In addition, it is already quite difficult anyway in compact cars to accommodate a coaxial tube heat exchanger of an air conditioning system in the engine compartment of the vehicle. If the tubular heat exchanger is to exhibit a bent or curved progression at one or more locations in the engine compartment, for example to save on space, problems may indeed be encountered with respect to how the heat exchanger operates. From a production standpoint, it is most often provided that the inner tube and outer tube of the heat exchanger be telescoped into each other to establish a flow-through intermediate space between the tubes.

In this case, either webs or ribs extending radially outward are to be provided on the external side of the inner tube, by means of which the inner tube abuts against the internal side of the outer tube. The tubes telescoping into each other are here curved or bent in an ensuing bending process. Individual flow channels of the intermediate space of the tube that were formed by the separating webs or ribs can in some cases become significantly constricted, so that the tubular curvature may impair the flow resistance of individual flow channels.

Depending on the bending or curving radius, individual flow channels can in extreme situations also be completely sealed or blocked by the bending process. If the goal is to curve or bend the tubular heat exchanger in different directions at several locations, this may cause any flow channels formed in the annular gap between the inner and outer tube to exhibit a flow resistance detrimental to an efficient operation of the heat exchanger, or even to become completely blocked.

In contrast, it is at least one object herein to provide an internal, tubular heat exchanger for a motor vehicle air conditioning system that is easy to universally adjust to existing geometric requirements. The heat exchanger is configured for comparatively small bending or curving radii, and despite the one or several bends, continues to exhibit a flow resistance favorable to operation of the heat exchanger, in particular with respect to the flow channels in the intermediate space between the inner and outer tube. In addition, other objects, desirable features and characteristics will become apparent from the subsequent summary and detailed description, and the appended claims, taken in conjunction with the accompanying drawings and this background.

### SUMMARY

The various exemplary embodiments provide for a heat exchanger that is a so-called internal heat exchanger for a motor vehicle air conditioning system. The internal heat exchanger exhibits an inner tube that can carry a heat exchanger medium, along with an outer tube preferably arranged concentrically thereto. The outer tube envelops the inner tube, forming one or more intermediate spaces through which the heat exchanger medium can flow, preferably opposite the flow of the inner tube.

One or more separating web extending between the inner and outer tube divides the intermediate space arising between the inner and outer tube into at least two flow channels separated from each other in the circumferential direction of the inner tube. Viewed in the radial direction, the separating web here extends between the external side of the inner tube and internal side of the outer tube, and adjoins the opposing boundary surfaces of the two tubes telescoping into each other.

The separating web in at least one axial section of the inner and outer tube fluidically couple the adjoining flow channels decoupled from each other by the separating web viewed in the circumferential direction of the inner tube. This permits at least a sectional fluid exchange between the flow channels separated from each other by the separating web.

In an exemplary embodiment, sections of the separating web are interrupted in the vicinity of a curve of the inner and/or outer tube. This enables the formation of a bypass channel, which can effectively compensate for the sectional flow channel constriction that inevitably arises in the vicinity of a curved tube. This is because, in the vicinity of the separating web interruption, the heat exchanger medium supplied to the web interruption by way of a channel can again be distributed to the flow channels provided downstream from the separating web interruption.

The fluidic coupling can here be established via a complete or partial interruption of the separating web in the radial direction, as well as recesses, holes and/or individual notches in the separating web. If one of the channels lying downstream from the interruption exhibits a deformation that elevates the flow resistance, for example, the heat exchanger medium flowing through the tubular heat exchanger in an axial direction can also be distributed to different channels in the circumferential direction of the inner tube.

It is here not absolutely essential that the interruption of the separating web forming the intermediate space flow channels lie in the curved region of the inner and/or outer tube. Therefore, the interruption can also be immediately adjacent to a curved region of the tube, for example in the tube section that traces a straight line. In this way, a bypass channel extending in the circumferential direction around the inner tube can be formed even directly adjacent to a curved section, while the actual curved region of the inner and/or outer tube is provided with separating webs throughout as viewed in the longitudinal direction of the tube. Even if the tubular heat exchanger exhibits several differently aligned bending points or curves, the regional interruption of the separating webs in the vicinity of the web interruptions makes it possible to respectively redistribute the heat exchanger medium to the different flow channels.

In another embodiment, the separating web is a single piece with the inner tube. At least three or more separating webs distributed in the circumferential direction are here provided, with which the inner tube can be made to abut against the inner wall of the outer tube.

In a further embodiment, the individual separating webs in this respect simultaneously act as a spacer for a concentric arrangement of the inner and outer tube. From a production standpoint, the radially outwardly projecting separating webs can be molded onto the inner tube. Aside from a single piece design, it is basically also conceivable to separately secure individual separating webs spaced axially apart from each other at a prescribed distance to the external side of the inner tube. However, if the inner tube is fabricated as an extruded profile section, for example, it is advantageous to either create the axial intermediate spaces between the separating webs by appropriately finishing the inner tube, e.g., by removing corresponding web sections, or to adjust the extrusion process furnished for creating the tube to the manufacture of radially outwardly protruding webs or ribs to be provided only regionally in the longitudinal direction of the tube.

In addition, the outer tube can have radially inwardly projecting separating or spacing webs, wherein use can preferably be made of an extrusion process as well.

With respect to both the arrangement of the inner and outer tube relative to each other and the functionality of the heat exchanger as a whole, several separating webs can be distributed in the circumferential direction of the inner tube. The separating webs can preferably be equidistantly arranged in the circumferential direction. For example, if only three separating webs are provided, they are preferably to be provided at an angular distance of 120° in the circumferential direction of the inner tube. The angle drops to 90° in the case of four separating webs, and to 60° for six separating webs, which reflects the regularity of 360° divided by the number of webs.

Aside from a uniform, equidistant arrangement of separating webs, however, it is also conceivable to establish a non-uniform arrangement, wherein at least one radially exterior section of the tube cross section can be provided with an elevated web thickness by comparison to the inner radius of the curve, in particular in the curved region of a heat exchanger.

In order to create a bypass channel that avoids the adverse impacts of a bent tube, another embodiment provides that all separating webs present in a plane lying transversal to the axial direction of the tubes exhibit an interrupted design to establish a bypass channel that annularly envelops the inner tube. The interruptions can here be provided in the area of the bent tube or directly adjacent hereto.

In a further embodiment, the separating webs at one end are adjacent to an imaginary interruption line or interruption plane perpendicular to the axial direction of the inner and/or outer tube, so that all flow channels formed by the separating webs together empty into the bypass channel, making it possible to largely compensate for a bottleneck formed downstream from the bypass channel in at least one downstream flow channel from the standpoint of fluid mechanics, because the heat exchanger medium becomes uniformly distributed over the sum total of flow cross sections made available by the individual flow channels.

Depending on the configuration of the heat exchanger, it can further be provided that only some of the separating webs are furnished with an at least regional interruption, so that the heat exchanger medium is not distributed to all channels, but only to those lying directly adjacent to a flow-constricted channel.

Regardless of whether all or only some of the separating webs exhibit a fluidic coupling or interruption, the separating webs can also exhibit interruptions that are axially offset relative to each other. This makes it possible to specifically control the flow redistribution in the heat exchanger.

It can further be provided that several bypass channels be furnished in the longitudinal or axial direction of the tubular heat exchanger, in the vicinity of which the separating webs or separating ribs are interrupted between the inner and outer tube. It can be provided in particular that several separating webs offset relative to each other in the axial direction and separated from each other via bypass channels be aligned with each other in the axial direction of the inner and/or outer tube.

Depending on the axial extension of the bypass channel(s), the flow resistance in the intermediate space between the inner and outer tube can be kept as low as possible by the aligned arrangement of adjacent separating webs in the axial direction.

However, it may further prove advantageous for the separating webs situated adjacent to each other in the axial direction and separated from each other via bypass channels to be offset relative to each other in the circumferential direction, for example for thermodynamic reasons. In this way, a turbulence of the heat exchanger medium flowing through the individual intermediate space channels can be supported or strengthened.

In an embodiment, the axial distance between two separating webs situated adjacent to each other in an axial direction measure between 2 mm and 12 mm, for example between 4 mm and 10 mm, such as, between 6 mm and 8 mm.

It also proves advantageous from the standpoint of fluid mechanics and with respect to a bending or curving of the tubes for the at least one separating web to exhibit an axial extension of between 15 mm and 60 mm, for example between 25 mm and 50 mm.

In another embodiment, the specific geometric configuration of the separating webs, their axial distance relative to each other, as well as the number thereof in the circumferential direction, also depend in particular on the radius of curvature to be provided for the curve in the inner and/or outer tube. To this extent, the axial length of the separating webs and/or the intermediate space between separating webs situated adjacent to each other in the axial direction is preferably geared to the mentioned radius of curvature.

In a further embodiment, the individual separating webs extend parallel to the longitudinal extension of the inner and/or outer tube viewed in the axial direction. Such a parallel alignment of the individual separating webs can maintain as low a flow resistance as possible in the intermediate space between the inner and outer tube of the internal heat exchanger.

In one embodiment, the inner tube of the overall tubular and essentially cylindrical heat exchanger is designed as a low-pressure line, while the outer tube is provided as a high-pressure line. A heat exchanger medium present in gaseous form here typically flows through the inner tube, while a heat exchanger medium present in predominantly a liquid form and placed under a high pressure flows through the outer tube or the intermediate space formed by the inner and outer tube.

Accordingly, in another embodiment, the heat exchanger is arranged in a refrigerant circuit of an air conditioning system, wherein opposing end sections of the inner tube can be situated downstream from an evaporator and upstream from a compressor, and opposing end sections of the outer tube can be situated upstream from an expansion device and downstream from a capacitor in the refrigerant circuit of a motor vehicle air conditioning system. It here generally holds true that the low-pressure line is configured to fluidically couple the evaporator and compressor, and the high-pressure line is configured to fluidically couple the capacitor and expansion device of the refrigerant circuit of the air conditioning system.

A motor vehicle air conditioning system exhibiting a refrigerant circuit that can carry a flow of heat exchanger medium is provided in accordance with another exemplary embodiment. The refrigerant circuit is equipped at least with a compressor, a capacitor, an expansion device and an evaporator, which are serially fluidically connected by means of corresponding lines of the refrigerant circuit, and coupled with each other in terms of fluid mechanics in order to circulate the refrigerant or heat exchanger medium. The refrigerant circuit here exhibits at least one previously described, preferably tubular heat exchanger, which enables the exchange of thermal energy between the low-pressure side or inlet side lying downstream from the evaporator and high-pressure side of the refrigerant circuit lying upstream from the expansion device.

A motor vehicle, which exhibits a previously described heat exchanger or an air conditioning system equipped herewith, is also provided in accordance with another embodiment.

Further provided is a method for manufacturing a heat exchanger. In an exemplary embodiment, the method includes inserting an inner tube having radially outwardly projecting separating webs interrupted in sections in an axial direction into an outer tube. The inner diameter of the outer tube here essentially corresponds to the outer diameter of the outer circumference of the inner tube formed by the radially outwardly protruding separating webs. After at least sections of the two tubes have been inserted into each other and formed an intermediate space between them, which is divided into several flow channels by the individual separating webs, both tubes are bent into a prescribed, at least regionally curved shape in a subsequent bending or other type of forming process in the area of at least one interruption in the separating webs of the inner tube. The bend can here also be introduced directly adjacent to a web interruption, making it possible to compensate for any bottlenecks in the individual intermediate space channels inevitably caused by the bend from the standpoint of fluid mechanics. The, preferably liquid, heat exchanger or refrigerant flowing in the intermediate space between the inner and outer tube can be distributed to the remaining intermediate space channels via the roughly annular bypass channel formed by the web interruption(s).

### BRIEF DESCRIPTION OF THE DRAWINGS

The various embodiments will hereinafter be described in conjunction with the following drawing figures, wherein like numerals denote like elements, and wherein:

FIG. 1 is a circuit diagram of a motor vehicle air conditioning system with an internal heat exchanger;

FIG. 2 is a cross-sectional view of an annular heat exchanger in accordance with an exemplary embodiment;

FIG. 3 is a side view of a curved section of the annular heat exchanger of FIG. 2;

FIG. 4 is a perspective, isolated view of an inner tube with separating webs interrupted in sections in accordance with an exemplary embodiment; and

FIG. 5 is a longitudinal section through an annular heat exchanger provided with interrupted separating webs in accordance with an exemplary embodiment.

### DETAILED DESCRIPTION

The following detailed description is merely exemplary in nature and is not intended to limit the application and uses of the embodiments contemplated herein. Furthermore, there is no intention to be bound by any theory presented in the preceding background or the following detailed description.

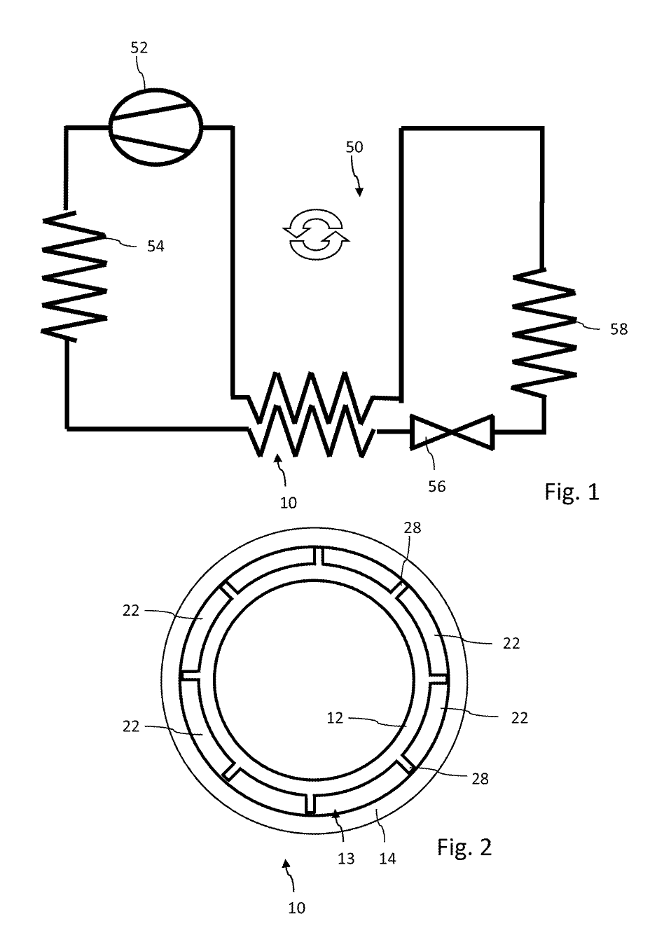

FIG. 1 presents a circuit diagram of an air conditioning circuit of a motor vehicle air conditioning system 50. The air conditioning system 50 exhibits a compressor 52 provided to compress the heat exchanger medium flowing in the refrigerant circuit, and a capacitor 54 situated downstream from the compressor 52 for discharging thermal energy to the environment. Provided downstream from the capacitor 54 is an internal heat exchanger 10, whose high-pressure line is fluidically coupled with an evaporator 58 allocated to the vehicle interior by means of an expansion device, in particular an expansion valve 56.

Downstream from the evaporator 58, the refrigerant or heat exchanger medium again flows through the internal heat exchanger 10 via a low-pressure side, until it is again compressed by the compressor 52. The efficiency of a motor vehicle air conditioning system 50 can be distinctly improved by means of the internal heat exchanger 10.

In this way, the refrigerant flowing back from the evaporator 58 can be used to further supercool the high-pressure refrigerant to be supplied to the expansion device 56. The typically tubular coaxial heat exchanger 10 to be provided for this purpose is shown on FIG. 2 in a cross section perpendicular to the longitudinal extension of two tubes 12, 14.

The air conditioner-internal heat exchanger 10 exhibits a round inner tube 12, which is enveloped by an outer tube 14 adapted to the geometry of the inner tube 12. A total of eight radially outwardly projecting webs 28 are molded to the inner tube 12 in the embodiment shown, and can be used to divide an intermediate space 13 formed between the inner tube 12 and outer tube 14 into a total of eight flow channels running in the axial direction 30 (shown in FIG. 4 to be discussed below) for the heat exchanger medium.

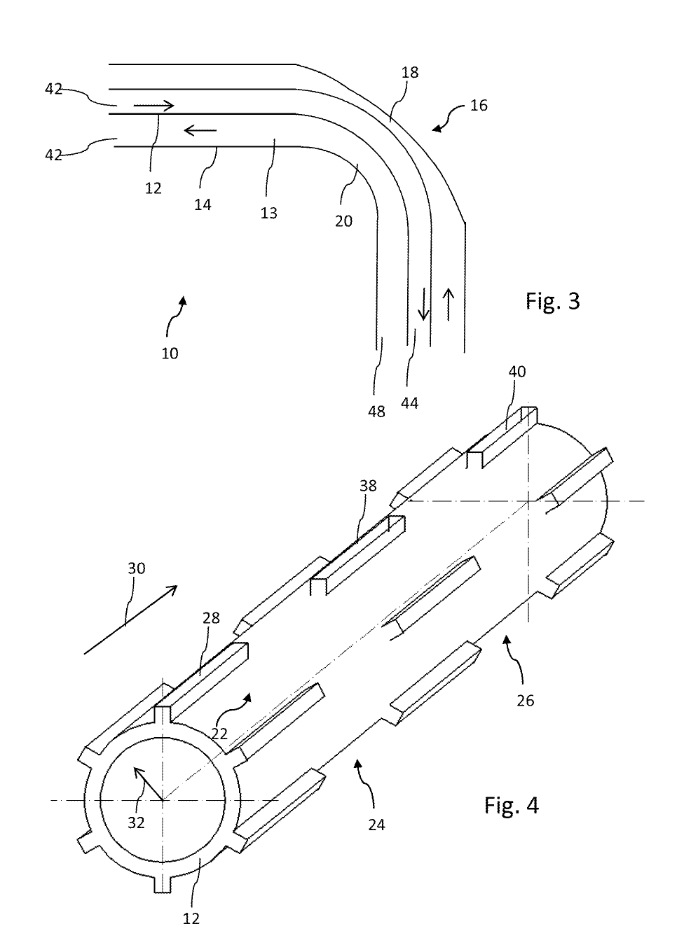

If the existing design envelope of a motor vehicle requires a bend or curve 16 in the tubular heat exchanger 10 as diagrammatically shown on FIG. 3, bending the inner and outer tube, in particular in the exterior curved area 18, can cause one or more flow channels 22 to become constricted, while the interior curved area 20 retains a nearly unchanged flow-through flow cross section.

If the flow channels 22 formed by the separating webs 28 exhibit no connection to each other in the circumferential direction, several flow channels 22 might be impaired in terms of their permeability to the heat exchanger medium, and hence also with respect to the functionality of the heat exchanger. In order to prevent this, the radially outwardly projecting separating webs 28 provided on the inner tube 12 are provided with individual interruptions in an axial direction 30, so as to form annular bypass channels 24, 26 enveloping the inner tube 12 in the circumferential direction at selected axial positions of the tubular heat exchanger 10, as illustrated in FIG. 4.

Such bypass channels 24, 26 are to be provided in particular in the area of a curved section 16 and/or immediately adjacent hereto, so that individual flow channels 22 do not become impaired in terms of their permeability over the axial extension of the heat exchanger 10, for example as the result of the curve. The bypass channels 24, 26 to be provided in particular in the area of the curved section 16 enable flow characteristics for the refrigerant flowing in the intermediate space 13 that span the flow channel.

FIG. 3 presents only a diagrammatic and sectional view of the heat exchanger 10, whose inlet 42 on the inner tube side is coupled with the outlet of the evaporator 58 sketched on FIG. 1, while the outlet 44 of the inner tube 12 is fluidically connected with the input or suction side of the compressor 52. By contrast, the heat exchanger medium present in the high-pressure line predominantly in liquid form flows through the intermediate space 13 formed between the inner tube 12 and outer tube 14 in the opposite direction. Accordingly, the inlet 48 of the outer tube 14 is situated downstream from the capacitor 54, while an opposing outlet 46 of the outer tube 14 is provided in the refrigerant circuit upstream from the expansion device 56.

From the standpoint of fluid mechanics and to reduce the flow resistance of the intermediate space 13 between the inner tube 12 and outer tube 14, it proves advantageous for the individual separating webs 28, 38, 40 situated adjacently to each other in an axial direction to be aligned relative to each other, and essentially run parallel to or along the longitudinal or axial direction 30 of the tubes 12, 14.

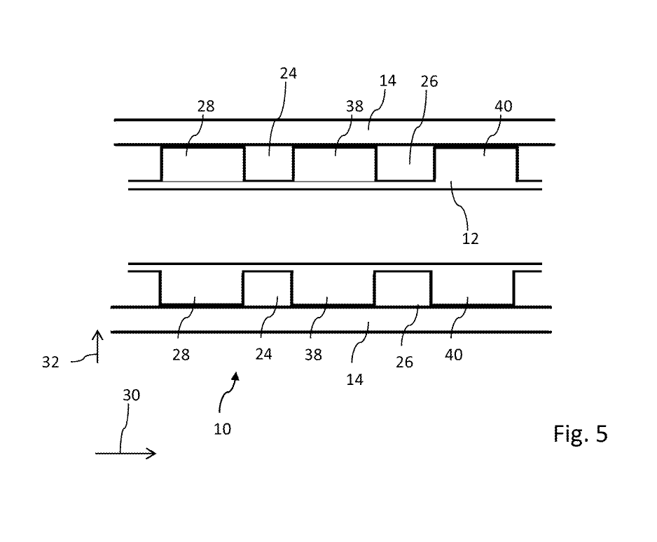

In order to form annular bypass channels 24, 26, it is additionally provided that the separating webs 28, 38, 40 coming to lie in a shared transversal plane and distributed in the circumferential direction on the inner tube 12 all abut against a shared, imaginary interruption line 36, which preferably extends perpendicular to the axial direction 30, as exemplarily shown on FIG. 5. In this way, a bypass channel 24, 26 annularly enveloping the inner tube can form in an axial segment of the tubular heat exchanger 10.

As may further be gleaned from the cross sectional view presented on FIG. 5 in the plane formed by the radial direction 32 and axial direction 30, the longitudinal or axial extension of the separating web sections 28, 38, 40 is greater than the intermediate space 24, 26 formed between the adjacent separating webs 28, 38, 40. The intermediate spaces formed between the separating webs 28, 38, 40 exhibit an axial extension, typically ranging from about 2 mm to about 12 mm, preferably from about 4 mm to about 10 mm, or about 6 mm to about 8 mm.

By contrast, the axial extension of individual separating webs 28, 38, 40 can vary from about 15 mm to about 60 mm, preferably from about 25 mm to about 50 mm, wherein such lengths or specified ranges can be variably adjusted to a prescribed geometry of the heat exchanger 10, along with its inner and outer tube 12, 14.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A heat exchanger for a motor vehicle air conditioning system, the heat exchanger comprising:
an inner tube configured to carry a heat exchanger medium;
an outer tube that at least regionally envelops the inner tube with an intermediate space between the inner tube and the outer tube; and
a separating web extending between the inner tube and the outer tube and configured to divide the intermediate space into at least two flow channels, wherein in an axial section of the inner tube and the outer tube the separating web fluidically couples the at least two flow channels with each other as viewed in a circumferential direction of the inner tube.

2. The heat exchanger according to claim 1, wherein sections of the separating web are interrupted in a vicinity of a curve of the inner tube and/or the outer tube or immediately adjacent thereto in order to establish a fluidic coupling of the at least two flow channels.

3. The heat exchanger according to claim 1, wherein the separating web is a single piece with the inner tube.

4. The heat exchanger according to claim 1, wherein the separating web simultaneously acts as a spacer for a concentric arrangement of the inner tube and the outer tube.

5. The heat exchanger according to claim 1, wherein a plurality of separating webs extend between the inner tube and the outer tube and are distributed in the circumferential direction of the inner tube.

6. The heat exchanger according to claim 1, wherein the separating web exhibits an interrupted design to establish a bypass channel that annularly envelops the inner tube.

7. The heat exchanger according to claim 1, wherein an imaginary interruption line adjoined by one end of the separating web extends substantially perpendicular to an axial direction of the inner tube and/or the outer tube.

8. The heat exchanger according to claim 1, wherein a plurality of separating webs offset relative to each other in an axial direction and separated from each other via bypass channels are aligned with each other in the axial direction.

9. The heat exchanger according to claim 8, wherein an intermediate space between two adjacent separating webs of the plurality of separating webs in the axial direction is based on a radius of curvature of curve in the inner tube and/or the outer tube.

10. The heat exchanger according to claim 8, wherein an axial distance between two adjacent separating webs of the plurality of separating webs is in the range of from about 2 mm to about 12 mm.

11. The heat exchanger according to claim 10, wherein the axial distance between the two adjacent separating webs of the plurality of separating webs is in the range of from about 4 mm to about 10 mm.

12. The heat exchanger according to claim 11, wherein the axial distance between the two adjacent separating webs of the plurality of separating webs is in the range of from about 6 mm to about 8 mm.

13. The heat exchanger according to claim 1, wherein the separating web comprises an axial extension in the range of from about 15 mm to about 60 mm.

14. The heat exchanger according to claim 13, wherein the separating web comprises the axial extension in the range of from about 25 mm to about 50 mm.

15. The heat exchanger according to claim 1, wherein an axial length of the separating web is based on a radius of curvature of a curve in the inner tube and/or the outer tube.

16. The heat exchanger according to claim 1, wherein opposing end sections of the inner tube are situated downstream from an evaporator and upstream from a compressor, and opposing end sections of the outer tube are situated upstream from an expansion device and downstream from a capacitor in a refrigerant circuit.

17. A motor vehicle air conditioning system with a refrigerant circuit that fluidically couples a compressor, a capacitor, an expansion device, and an evaporator with each other to circulate a refrigerant, and that further includes a heat exchanger comprising:
an inner tube configured to carry a heat exchanger medium;
an outer tube that at least regionally envelops the inner tube with an intermediate space between the inner tube and the outer tube; and
a separating web extending between the inner tube and the outer tube and configured to divide the intermediate space into at least two flow channels, wherein in an axial section of the inner tube and the outer tube the separating web fluidically couples the at least two flow channels with each other as viewed in a circumferential direction of the inner tube.

18. A motor vehicle with an air conditioning system having a refrigerant circuit that fluidically couples a compressor, a capacitor, an expansion device, and an evaporator with each other to circulate a refrigerant, and that further includes a heat exchanger comprising:
an inner tube configured to carry a heat exchanger medium;
an outer tube that at least regionally envelops the inner tube with an intermediate space between the inner tube and the outer tube; and
a separating web extending between the inner tube and the outer tube and configured to divide the intermediate space into at least two flow channels, wherein in an axial section of the inner tube and the outer tube the separating web fluidically couples the at least two flow channels with each other as viewed in a circumferential direction of the inner tube.

19. A method for manufacturing a heat exchanger, the method comprising the steps of:
providing an inner tube with radially outwardly projecting separating webs interrupted in sections in an axial direction;
inserted the inner tube into an outer tube; and
bending both tubes into a prescribed, at least regionally curved shape in an area of an interruption in a separating web of the inner tube.
